(19) United States
(12) Patent Application Publication
(10) Pub. No.: US 2017/0160840 A1
(43) Pub. Date: Jun. 8, 2017

(54) DIGITIZER WITH HIGH ACCURACY OF IDENTIFYING POSITION

(71) Applicant: TRAIS CO., LTD., Ansan-si, Gyeonggi-do (KR)

(72) Inventors: Sung Yeop JOUNG, Daejeon (KR); Hong Chae KIM, Ansan-si (KR); Kwang Gu LEE, Ansan-si (KR)

(73) Assignee: TRAIS CO., LTD., Ansan-si, Gyeonggi-do (KR)

(21) Appl. No.: 14/781,087

(22) PCT Filed: Jun. 29, 2015
(86) PCT No.: PCT/KR2015/006608

§ 371 Date: Sep. 29, 2015

(30) Foreign Application Priority Data
Aug. 25, 2014 (KR) 10-2014-0110791
Sep. 17, 2014 (KR) 10-2014-0123437

(51) Int. Cl. G06F 3/046; G06F 3/0354; G06F 3/041

(52) U.S. Cl. CPC G06F 3/046; G06F 3/0418; G06F 3/0414; G06F 3/03545

(57) ABSTRACT

Provided is a digitizer with high accuracy of identifying a position, and more particularly, to a digitizer with high accuracy of identifying a position, in which a plurality of magnetic force sensors are installed to collect a plurality of pieces of position information regarding a magnetic force pen and a position of the magnetic force pen is determined by using only position information selected according to a specific reference. Since only information with high reliability, among pieces of position information of the magnetic force pen measured by the plurality of magnetic force sensors, is used, accuracy of identifying a position of the magnetic force pen may be increased.

### TECHNICAL FIELD

The present invention relates to a digitizer with high accuracy of identifying a position, and more particularly, to a digitizer with high accuracy of identifying a position, in which a plurality of magnetic force sensors are installed to collect a plurality of pieces of position information regarding a magnetic force pen and a position of the magnetic force pen is determined by using only position information selected according to a specific reference.

### BACKGROUND TECHNOLOGY

A digitizer, a type of input device used in display equipment, refers to a device having an matrix type electrode structure, reading X and Y coordinates on a matrix when a user moves a pen or a cursor, and transferring a position signal of the input device to a control unit to perform a corresponding command.

The digitizer is also called a touch panel or a tablet in a broad sense, and is classified as a resistive digitizer, a capacitive digitizer, and a magnetic digitizer according to position detection schemes. However, the digitizer may be distinguished from a touch panel so as to be used according to circumstances.

A display device of display equipment such as mobile terminals or tablet PCs includes a cover glass, a touch panel, a liquid crystal panel, and a digitizer, and with the recent development of display industries, display devices or display equipment integrating these elements or differentiating configurations of these elements have emerged.

However, when a touchscreen type digitizer is implemented by installing a separate magnetic force sensor panel, the number of panels to be attached increases, making a structure of the device complicated, increasing manufacturing cost, and causing a difficulty in repairing or replacing elements when an error occurs.

In order to solve the problem, techniques of installing a magnetic force sensor inside a digitizer and identifying a position of a magnetic force pen by measuring characteristics of a variation of a magnetic field generated by a magnetic force pen have been introduced. However, even with such a device, an error of position information occurs due to an error unique to each magnetic force sensor, and related arts have limitations in improving such a fundamental error.

### TECHNICAL SOLUTIONS

Accordingly, the present invention provides a digitizer with high accuracy of identifying a position, in which a plurality of magnetic force sensors are disposed, a plurality of pieces of position information and movement information regarding a magnetic force pen are detected by sensing a change in a magnetic field generated according to a movement of the magnetic force pen, and a position of the magnetic force pen is determined by selecting only information with high reliability from among the plurality of pieces of position information and movement information.

The present invention also provides a digitizer with high accuracy of identifying a position, capable of estimating an accurate position of a magnetic force pen when a magnetic force sensor collecting position information for determining a position of a magnetic force pen is changed, by inputting immediately previous position information and movement information of the magnetic force pen to a position correction algorithm.

In one general aspect, a digitizer with high accuracy of identifying a position, in which a plurality of magnetic force sensors are installed to collect a plurality of pieces of position information regarding a magnetic force pen, and a position of the magnetic force pen is determined by using only position information selected according to predetermined selection reference among the plurality of pieces of collected position information, includes: a touchscreen configured to display an image; a magnetic force pen configured to move at an upper side of a front surface of the touchscreen, while a magnetic material generates a three-dimensional (3D) magnetic field distribution; a plurality of magnetic force sensors installed inside a case and configured to measure a direction and a magnitude of a 3D magnetic field generated by the magnetic force pen; and a control unit configured to select a portion of the plurality of pieces of position information collected by the plurality of magnetic force sensors to determine a position of the magnetic force pen, wherein the selection reference for the control unit to select the position information is a magnitude value of a magnetic field vector, and the control unit calculates a position of the magnetic force pen by selecting one or two pieces of position information having the largest magnitude value of the magnetic field vector among the pieces of position information input from the plurality of magnetic force sensors.

When the two pieces of position information having the largest magnitude value of the magnetic field vector are selectively calculated, the control unit may calculate a position of the magnetic force pen by calculating a function of X, Y, and Z-axis directional components and a tilt from magnetic field vectors obtained from the two pieces of selected position information.

When the magnetic force sensor for collecting the position information is changed as the magnetic force pen moves, the control unit may correct a position of the magnetic force pen through a position correction algorithm of adding a value measured by the magnetic force sensor and a value estimated on the basis of past information of the magnetic force pen by applying different weight values thereto.

The position correction algorithm may be any one of the Kalman filter and the Particle filter.

Other features and aspects will be apparent from the following detailed description, the drawings, and the claims.

### ADVANTAGEOUS EFFECTS

As described above, according to the present invention, since only information with high reliability, among pieces of position information of the magnetic force pen measured by the plurality of magnetic force sensors, is used, accuracy of identifying a position of the magnetic force pen may be increased.

### DESCRIPTION OF DRAWINGS

FIG. 1 is a perspective view illustrating a structure of a digitizer according to an embodiment of the present invention.

FIG. 2 is a plan view illustrating a way in which a magnetic force sensor identifies a position of a magnetic force pen.

FIG. 3 is a conceptual view illustrating a way in which a position of the magnetic force pen is identified when the magnetic force pen is within a region of the magnetic force sensor.

FIG. 4 is a conceptual view illustrating a way in which a position of the magnetic force pen is identified when the magnetic force pen is outside of the region of the magnetic force sensor.

FIG. 5 is a plan view illustrating a state in which the magnetic force sensor sensing a magnetic force pen is replaced.

FIG. 6 is a conceptual view illustrating a way in which an estimate movement path is calculated on the basis of past information of the magnetic force pen.

### BEST MODE

Hereinafter, a “digitizer with high accuracy of identifying a position (hereinafter, referred to as a “digitizer”)” according to embodiments of the present invention will be described in detail with reference to the accompanying drawings.

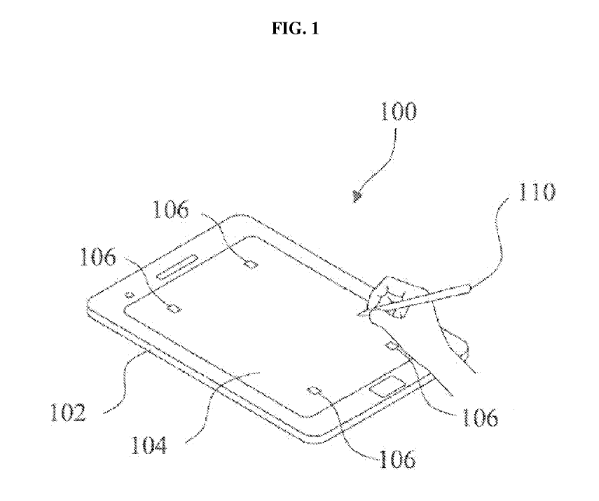

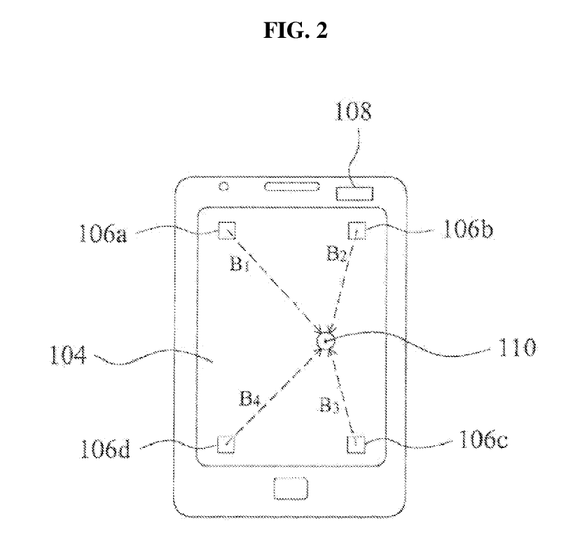

FIG. 1 is a perspective view illustrating a structure of a digitizer according to an embodiment of the present invention, and FIG. 2 is a plan view illustrating a way in which a magnetic force sensor identifies a position of a magnetic force pen.

A digitizer 100 has a function of identifying a position of a magnetic force pen 110 by measuring a magnetic force distribution, while displaying an image signal. The digitizer 100 includes a touchscreen 104 displaying an image on a front surface of a case 102 forming a body. A user may write or input a command by touching the touchscreen 104 with his or her finger, a stylus pen, or the magnetic force pen 110. Thereamong, the magnetic force pen 110 includes a magnetic material to generate a three-dimensional (3D) magnetic force distribution.

The magnetic force pen 110 freely moves in an upper portion of a front surface of the touchscreen 104, and a 3D magnetic field distribution generated herein is detected by a magnetic force sensor 106 and a movement trace is visually expressed on the touchscreen 104.

The touchscreen 104 includes a touch panel for sensing a contact signal, a circuit board for controlling input and output of a signal, and a cover window for protecting the touch panel. These components are the same as those of the related art, and thus a detailed description thereof will be omitted.

A plurality of magnetic force sensors 106 are installed inside the case 102. The magnetic force sensors 106 may be positioned on an upper surface or a lower surface of a cover window, a circuit board, or a touch panel. The magnetic force sensors 106 may be installed in a marginal portion (bezel region) of the touchscreen 104 in which an image is not displayed, or may be installed in a middle portion (an inner region of the bezel) in which an image is displayed in order to accurately sense a position of the magnetic force pen 110. In the present invention, it is described that the magnetic force pen 110 is installed in the middle portion and it is configured such that a polygon formed by the plurality of magnetic force pens 110 as a vertex is smaller than the polygon (largely, a rectangle) forming the touchscreen 104 and included therewithin. The magnetic force sensor 106 calculates a position, a movement direction, and a tilt of the magnetic force pen 110 by measuring a magnetic field generated by the magnetic force pen 110 or a change in the magnetic field.

The magnetic force sensor 106 measures a magnetic force in space rectangular coordinates 3-axis directions by using a Hall effect, a search coil induction effect, a flux gate induction effect, a magneto-resistive effect.

A magnetic field as a vector is generated by the magnetic force pen 110. The magnetic force sensor 106 may measure a directional component and a magnitude value of the magnetic field generated by the magnetic force pen 110. When a magnitude of each directional component of the magnetic field vector is known, a direction and a magnitude of the overall magnetic field may be calculated. Theoretically, a direction and a magnitude of a magnetic field generated by the magnetic force pen 110 may be obtained by only a single magnetic force sensor 106, and thus, whether the magnetic force pen 110 is on the touchscreen 104 may be checked. In the present invention, in order to increase accuracy of identifying a position of the magnetic force pen 110, a plurality of magnetic force sensors 106 are used.

As illustrated in FIGS. 1 and 2, the digitizer 100 is configured on the assumption that the rectangular touchscreen 104, the shape of general smartphone or mobile terminal is used. Also, it is assumed that four magnetic force sensors 106 are installed in the vicinity of four corners of the touchscreen 104. The present invention may be applied as long as two or more magnetic force sensors 106 are installed, but generally, four magnetic force sensors 106 may be used.

In the present invention, it is assumed that the touchscreen 104 has a general rectangular shape in which a length is longer than a width and, starting from a first magnetic force sensor 106a installed at a left upper end, a second magnetic force sensor 106b, a third magnetic force sensor 106c, and a fourth magnetic force sensor 106d are installed in a clockwise direction.

A magnetic field generated by the magnetic force pen 110 is sensed by each of the magnetic force sensors 106. A vector value sensed by the first magnetic force sensor 106a is

$${\to }_{B 1} ,$$

and vector values sensed by the second magnetic force sensor 106b, the third magnetic force sensor 106c, and the fourth magnetic force sensor 106d are

$${\to }_{B 2} , {\to }_{B 3} , and {\to }_{B 3} ,$$

respectively. Each of the vector values has directional components of x axis, y axis, and z axis, and an absolute value (a magnitude value of the vectors) may be obtained by vector-calculating the magnitudes of the three components. The magnitude values of the three vector values are

$$\vert {\to }_{B 1} \vert , \vert {\to }_{B 2} \vert , \vert {\to }_{B 3} \vert , and \vert {\to }_{B 4} \vert ,$$

respectively.

When a position and a tilt of the magnetic force pen 110 having a magnetic material are changed, a magnetic field measured by the magnetic force sensor 106 fixed to a predetermined position is changed. A value measured by the magnetic force sensor 106 is a vector of the magnetic field in the X, Y, and Z directions at the point, and the magnetic field is a function of the x, y, and z coordinates and a tilt of the magnetic force pen 110. When an inverse function of the magnetic field strength change function is taken, 5-axis coordinates x, y, z, θ, and φ may be converted.

A method of identifying a position of the magnetic force pen 110 by using four magnetic force sensors 106 will be described in detail.

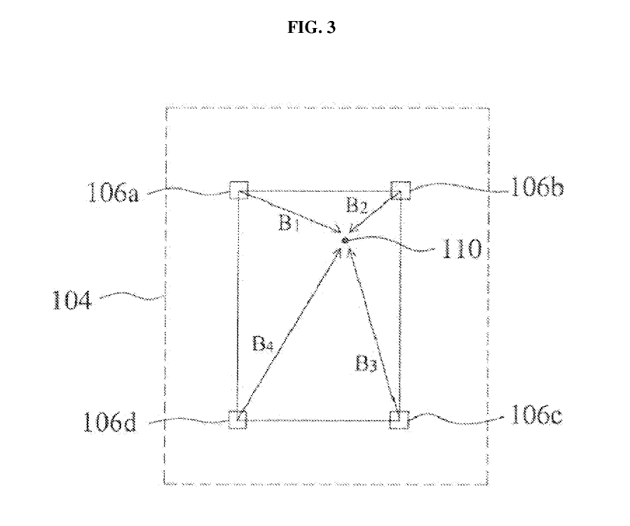

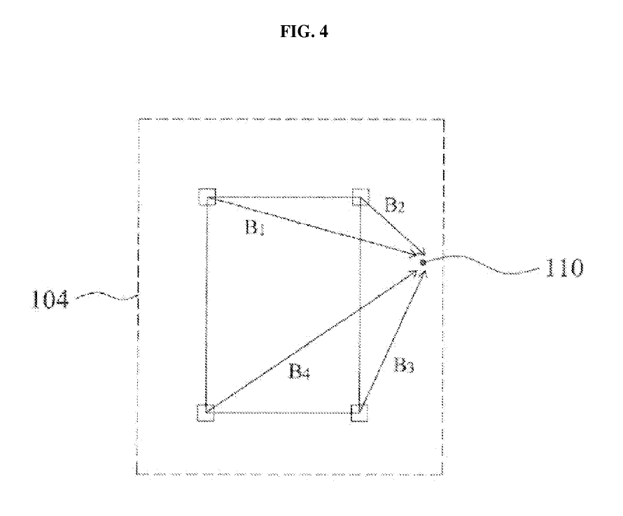

FIG. 3 is a conceptual view illustrating a way in which a position of the magnetic force pen is identified when the magnetic force pen is within a region of the magnetic force sensor, and FIG. 4 is a conceptual view illustrating a way in which a position of the magnetic force pen is identified when the magnetic force pen is outside of the region of the magnetic force sensor.

As illustrated in FIG. 3, the magnetic force pen 110 is generally within a virtual rectangular region formed by four magnetic force sensors 106. However, since a rectangle formed by the magnetic force sensors 106 is smaller than that of the touchscreen 104, the magnetic force pen 110 may be present outside of the rectangle formed by the magnetic force sensors 106 according to circumstances. The magnetic force sensors 106 may identify an accurate position of the magnetic force pen 110 in any event.

Each of the magnetic force sensors 106 calculates a magnitude value and a directional component of the sensed magnetic field vector, and calculates how long it is away in which direction. An accurate position may be determined by using all of four measurement values.

However, the four magnetic force sensors 106 generate an error theoretically, resulting in a frequent occurrence that four measurement values are not completely identical in some cases. That is, the vector value arrows (straight lines pointing toward the magnetic force pen from each of the magnetic force sensors) illustrated in FIG. 3 or 4 do not cross at one point accurately. In this case, an error in which a position of the magnetic force pen 110 is displayed to exist in a region having a predetermined size occurs. In the present invention, in order to remove the error occurring due to a difference of the magnetic force sensors 106, only a portion of the values measured by the magnetic force sensors 106 may be used to identify an actual position.

When only a portion of the measured magnetic field vector values is used, a reference for selecting the vector values is a magnitude (absolute value) of the vectors. That is, four magnetic field vector values respectively calculated by four magnetic force sensors 106 are arranged in order of magnitude, starting from the largest vector value, and among them, a vector value is selected according to a predetermined reference. In the present invention, it is assumed that two greater vector values, among four vector values, are used. The other two smaller vector values are excluded by a control unit 108.

The reason for using the largest magnetic field vector value to calculate a position is because there is a probability in which as a distance between the magnetic force sensors 106 and the magnetic force pen 110 is reduced, a magnitude of a magnetic field is increased and an error of a measured value is reduced. A value measured in a state in which a distance between the magnetic force pen 110 and the magnetic force sensors 106 is large may reflect a greater error due to terrestrial magnetism or a magnetic field of other electronic device. However, it may be admitted that, when a distance therebetween is small so the measured value is large, an influence of an external factor thereon is reduced, and thus, reliability thereof is increased.

Referring to the example of FIG. 3, the magnetic force pen 110 is inclined to be positioned at the right upper end. In this case, a magnitude of a magnetic field sensed by the second magnetic force sensor 106b may be the largest and a magnitude of a magnetic field sensed by the first magnetic force sensor 106a may be the second-largest. The control unit 108 takes vector values measured by the second magnetic force sensor 106b and the first magnetic force sensor 106a, and discards vector values measured by the third magnetic force sensor 106c and the fourth magnetic force sensor 106d. Thus, the control unit 108 determines a position of the magnetic force pen 110 by using the vector value

$$( {\to }_{B 2} )$$

measured by the second magnetic force sensor 106b and the vector value

$$( {\to }_{B 1} )$$

measured by the first magnetic force sensor 106a.

Also, as illustrated in FIG. 4, the magnetic force pen 110 may be present outside of a line connecting the second magnetic force sensor 106b and the third magnetic force sensor 106c. Here, magnitude values of magnetic field vectors sensed by the second magnetic force sensor 106b and the third magnetic force sensor 106c may be the largest. The control unit 108 identifies a position of the magnetic force pen 110 by using the values measured by the two sensors (the second magnetic force sensor and the third magnetic force sensor).

Since the magnetic force pen 110 moves on the touchscreen 104 by the user, the magnetic force sensors 106 to be measured may be changed according to positions. Here, however, when the magnetic force sensor 106 is changed, that is, when the magnetic force pen 110 crosses a boundary line of a region handled by each of the magnetic force sensors 106, a position cannot be accurately identified due to an internal error of the magnetic force sensors 106. Thus, in order to complement the error the moment the magnetic force sensor 106 is changed, a position correction algorithm is applied.

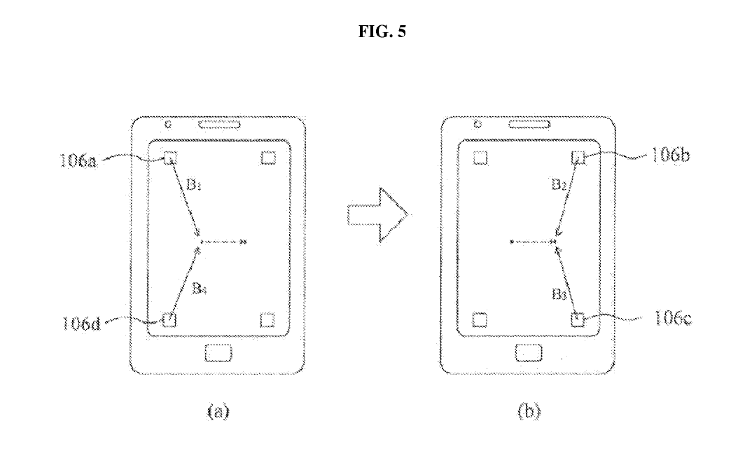

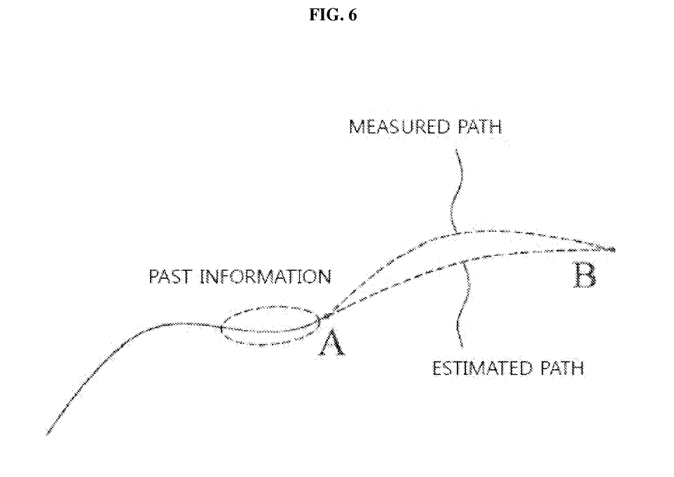

FIG. 5 is a plan view illustrating a state in which the magnetic force sensor sensing a magnetic force pen is replaced, and FIG. 6 is a conceptual view illustrating a way in which an estimate movement path is calculated on the basis of past information of the magnetic force pen.

In FIG. 5, a position of the magnetic force pen 110 is relatively close to the first magnetic force sensor 106a and the fourth magnetic force sensor 106d, and thus, the position of the magnetic force pen 110 is obtained from measurement values of the first magnetic force sensor 106a and the fourth magnetic force sensor 106d (please refer to (a)).

In this state, when the magnetic force pen 110 moves to the right to reach a region closer to the second magnetic force sensor 106b and the third magnetic force sensor 106c, sensing targets are changed to the second magnetic force sensor 106bh and the third magnetic force sensor 106c (please refer to (b)).

If a measurement error of a magnetic field occurring at the moment of the change is not considered, an error (measured path) as illustrated in FIG. 6 occurs. That is, the control unit 108 recognizes that the magnetic force pen 110 has been in an area different from a position to which the magnetic force pen 110 has actually moved. In order to correct a corresponding error, a process of estimating a path along which the magnetic force pen 110 has moved from A to B and combining the estimated path with an actually measured value is performed. That is, a value (a measurement position of the magnetic force pen) measured by the magnetic force sensor 106 and a value (estimated position of the magnetic force pen) estimated on the basis of past information of the magnetic force pen 110 are added by applying different weights thereto.

As a method for estimating a future movement or position on the basis of a past movement of a moving target, various position correction algorithms are used, and in the present invention, one of the Kalman filter and the Particle filter is used.

A position, a speed, and acceleration of an object may be measured by using a sensor, and here, a measurement value may include noise. In particular, there is a high possibility that noise increases the moment the magnetic force sensor 106 as a measurement target is changed, and thus, it is required to remove a rapid position variation sensed by the magnetic force sensor 106 to a degree.

The Kalman filter, a typical position correction algorithm, estimates a position at the present point in time by using information of positions of past points in time on the assumption that a position at a specific point in time is linearly related to a position of a previous point in time. The control unit 108 corrects information of the actually measured position in consideration of the estimated position of the present point in time. In order to correct the position, both actually measured information (path) and estimated information (path) are used, and here, accuracy may be increased by applying a weight in an appropriate manner.

The Particle filter is an algorithm of calculating a position of an object stochastically and correcting the position. That is, a current position of an object is expressed by a probability distribution, and when actual measurement values are accumulated, the probability distribution is changed, and thus, it is estimated that the object is present at a point having the highest probability.

The Kalman filter and the Particle filter are algorithms for correcting a position of a moving object, and in addition, various types of known techniques may be applied.

Also, when a sensor panel combining existing digitizer input schemes (a capacitive scheme, resistive scheme, an optical recognition scheme, an ultrasonic reflective scheme, and an electromagnetic induction scheme) using different physical measurement methods and a digitizer pen are used, an unconscious input or external input of a functional element may be selected and limited, allowing for a digitizer input on an accurate purpose.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

1. A digitizer with high accuracy of identifying a position, in which a plurality of magnetic force sensors are installed to collect a plurality of pieces of position information regarding a magnetic force pen, and a position of the magnetic force pen is determined by using only position information selected according to predetermined selection reference among the plurality of pieces of collected position information, the digitizer comprising:
a touchscreen configured to display an image;
a magnetic force pen configured to move at an upper side of a front surface of the touchscreen, while a magnetic material generates a three-dimensional (3D) magnetic field distribution;
a plurality of magnetic force sensors installed inside a case and configured to measure a direction and a magnitude of a 3D magnetic field generated by the magnetic force pen; and
a control unit configured to select a portion of the plurality of pieces of position information collected by the plurality of magnetic force sensors to determine a position of the magnetic force pen,
wherein the selection reference for the control unit to select the position information is a magnitude value of a magnetic field vector, and the control unit calculates a position of the magnetic force pen by selecting one or two pieces of position information having the largest magnitude value of the magnetic field vector among the pieces of position information input from the plurality of magnetic force sensors.

2. The digitizer of claim 1, wherein when the two pieces of position information having the largest magnitude value of the magnetic field vector are selectively calculated, the control unit calculates a position of the magnetic force pen by calculating a function of X, Y, and Z-axis directional components and a tilt from magnetic field vectors obtained from the two pieces of selected position information.

3. The digitizer of claim 1, wherein when the magnetic force sensor for collecting the position information is changed as the magnetic force pen moves, the control unit corrects a position of the magnetic force pen through a position correction algorithm of adding a value measured by the magnetic force sensor and a value estimated on the basis of past information of the magnetic force pen by applying different weight values thereto.

4. The digitizer of claim 3, wherein the position correction algorithm is any one of the Kalman filter and the Particle filter.
